(19) United States
(12) Patent Application Publication
(10) Pub. No.: US 2007/0187474 A1
(43) Pub. Date: Aug. 16, 2007

(54) METHOD, SYSTEM, AND COMPUTER PROGRAM PRODUCT FOR MANAGING TECHNOLOGY INFORMATION ASSOCIATED WITH A SUPPLY CHAIN

(75) Inventors: Edmund D. Blackshear, Wappingers Falls, NY (US); William B. Bornstein, Hopewell Junction, NY (US); Biao Cai, Carmel, NY (US); John S. Maresca, Hopewell Junction, NY (US); Joseph H. Torella, Lagrangeville, NY (US)

Correspondence Address: CANTOR COLBURN LLP - IBM FISHKILL, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/307,670

(22) Filed: Feb. 16, 2006

(51) Int. Cl. G06F 17/00; G06F 7/00; G06Q 30/00; G06Q 10/00

(52) U.S. Cl. 235/375; 235/376; 235/385; 705/28

(57) ABSTRACT

A method, system, and computer program product for managing technology information associated with a supply chain is provided. The method includes gathering technology data from suppliers. The technology data includes materials and processes used in manufacturing components. The method also includes mapping the technology data to component part numbers that utilize the materials and processes. The method further includes mapping the component part numbers to supplier quality data. The supplier quality data includes supplier performance information associated with manufacturing the components. The method also includes creating a database of records using results of the gathering and mappings. The database of records is searchable by component part numbers and at least one of the materials, processes, and supplier quality data.

### BACKGROUND OF THE INVENTION

The present invention relates generally to supply chain management and, more particularly, to a method, system, and computer program product for managing technology information associated with a supply chain.

Manufacturing enterprises operate data storage devices that store component part data for parts involved in their manufacturing processes. Over time, these databases typically grow in size as the manufacturing enterprise business grows, with parts potentially numbering in the hundreds of thousands. In addition, each of these parts may have as many as 100 parameters that are related to the manufacturing processes and/or consumption of the parts, independent of their function. Managing such databases can be a formidable task, particularly where frequent updates to the data are required.

A popular trend in electronics manufacturing involves contracting out some or all of the manufacturing of a company's products to third party manufacturers which then build these products according to specification. This arrangement, known as outsourcing, results where the original manufacturer (called an Original Equipment Manufacturer, or OEM) buys assemblies in bulk from third-party contract manufacturers (also referred to as suppliers) and then customizes them for a particular application. It then markets and sells the customized equipment under its own name. As product designs and components are becoming increasingly complex and frequently updated, a contract manufacturer with specialized skills may be better equipped to accommodate the changing technology.

Notwithstanding, OEMs typically require detailed and accurate information for its components with respect to composition and manufacturing processes used by suppliers who provide these manufacturing services to the OEMs. One reason for this is because new (or changes to existing) technologies, processes, and/or suppliers are usually a frequent occurrence in today's marketplace. Another reason is because OEMs may be subject to performance, regulatory, and/or warranty exposure due to changes in technologies implemented by their suppliers. In addition, from a business perspective, it is useful and important to identify any quality, function, or reliability issues associated with materials used at different points in the supply chain. However, as indicated above, maintaining and updating databases to reflect this continuously changing technology is cost prohibitive and labor intense.

What is needed, therefore, is a way to manage new and changing technology information across a supply chain.

### SUMMARY OF THE INVENTION

The foregoing discussed drawbacks and deficiencies of the prior art are overcome or alleviated by a method, system, and storage medium for managing technology information associated with a supply chain. The method includes gathering technology data from suppliers. The technology data includes materials and processes used in manufacturing components. The method also includes mapping the technology data to component part numbers that utilize the materials and processes. The method further includes mapping the component part numbers to supplier quality data. The supplier quality data includes supplier performance information associated with manufacturing the components. The method also includes creating a database of records using results of the gathering and mappings. The database of records is searchable by component part numbers and at least one of the materials, processes, and supplier quality data.

The system for managing technology information associated with a supply chain, includes a host system and a technology management application executing on the host system. The technology management application gathers technology data from suppliers. The technology data includes materials and processes used in manufacturing components. The technology management application also maps the technology data to component part numbers that utilize the materials and processes. The technology management application further maps the component part numbers to supplier quality data. The supplier quality data includes supplier performance information associated with manufacturing the components. The method also includes creating a database of records using results of the gathering and mappings. The database of records is searchable by component part numbers and at least one of the materials, processes, and supplier quality data.

The computer program product for managing technology information associated with a supply chain includes instructions for performing a method. The method includes gathering technology data from suppliers. The technology data includes materials and processes used in manufacturing components. The method also includes mapping the technology data to component part numbers that utilize the materials and processes. The method further includes mapping the component part numbers to supplier quality data. The supplier quality data includes supplier performance information associated with manufacturing the components. The method also includes creating a database of records using results of the gathering and mappings. The database of records is searchable by component part numbers and at least one of the materials, processes, and supplier quality data.

### BRIEF DESCRIPTION OF THE DRAWINGS

Referring to the exemplary drawings wherein like elements are numbered alike in the several FIGURES:

FIG. 1 is a block diagram of a system upon which the technology management activities may be implemented in exemplary embodiments;

FIG. 2 is a flow diagram describing a process for implementing the technology management activities in exemplary embodiments;

FIG. 3 is a user interface screen generated by the technology management application as seen by a supplier system in exemplary embodiments; and

FIG. 4 is a supplier technology qualification record generated by the technology management application in exemplary embodiments.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### DETAILED DESCRIPTION OF THE EXEMPLARY EMBODIMENTS

Disclosed herein is a method, system, and storage medium for managing technology information associated with a supply chain. Technology information is gathered from various sources and mapped to related components, bill of material (BOM) structures, and supplier quality information via supplier technology qualification (STQ) records. Any new technology information and/or changes to existing technology information is also mapped to component parts, BOM structures, and supplier quality information via the STQ records. A searchable database of these records is created so that manufacturers can derive specific information regarding quality, function, and reliability issues occurring at any point in the supply chain.

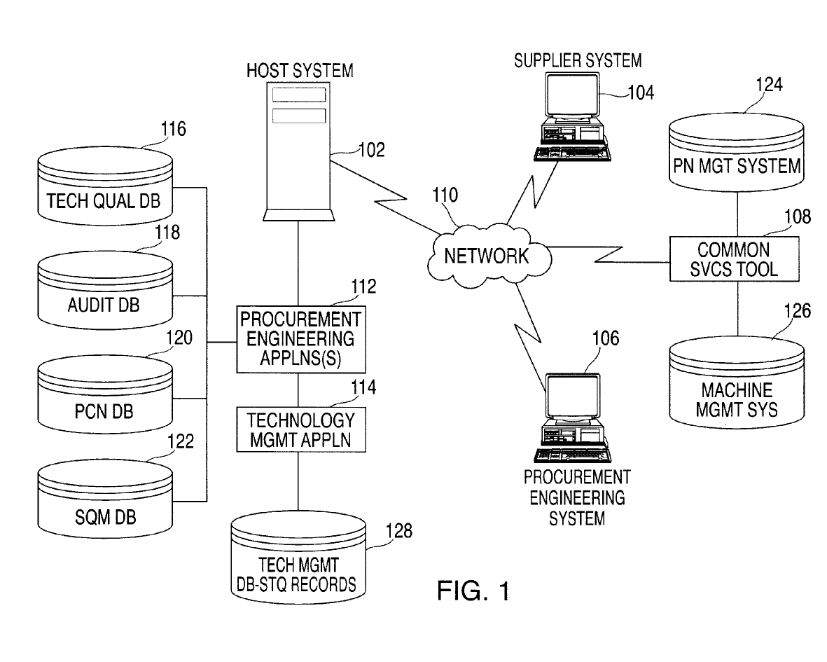

Turning now to FIG. 1, a system upon which the technology management activities may be implemented in accordance with exemplary embodiments will now be described. The system of FIG. 1 includes a host system 102 in communication with a supplier system 104, a procurement engineering system 106, and a common services tool 108 via a network 110.

Host system 102 may be implemented by a manufacturing entity that builds products for end users such as commercial, military, and organizational establishments, as well as personal consumers. In accordance with exemplary embodiments, the manufacturing entity of host system 102 is an original equipment manufacturer (OEM).

Host system 102 may be implemented using one or more servers or suitable high-speed processors operating in response to a computer program stored in a storage medium accessible by the server or servers. The host system 102 may operate as a network server (e.g., a web server) to communicate with network entities such as supplier system 104, procurement engineering system 106, and common services tool 108. The host system 102 may handle sending and receiving information to and from these network entities and may perform associated tasks.

Host system 102 may also operate as an application server. In accordance with exemplary embodiments, the host system 102 executes one or more computer programs 112 to perform procurement engineering activities. In addition, host system 102 executes a technology management application 114 for performing technology management activities. It will be understood that technology management application 114 may be a standalone application that includes the functionality provided by the procurement engineering applications 112 or may be an application programming interface (API) of the procurement engineering applications 112. In addition, the host system 102 may further implement other suitable applications typically employed by a manufacturing enterprise (e.g., a material control system (MCS) application, manufacturing execution system (MES), etc.). The host system 102 processes various types of data via the procurement engineering applications 112, technology management application 114, and other suitable applications.

As previously described, it is understood that separate servers may be utilized to implement the network server functions and the application server functions of host system 102. Alternatively, the network server and the application server may be implemented by a single server executing computer programs to perform the requisite functions described with respect to host system 102.

The technology management application 114 may include a user interface (UI) for enabling individuals of the manufacturing entity of host system 102 to perform technology management activities, as described further herein. Supplier technology qualification (STQ) records are generated by the technology management application 114 and may be stored locally on host system 102 or at a remote location, as desired. As shown in the system of FIG. 1, STQ records are stored in a technology management database 128 and are accessible to the technology management application 114. STQ records store results of technology management activities as described further herein. Technology management database 128 also stores technology-specific questionnaires that include standardized information elements for selection and input by a supplier for a given technology. These questionnaires are described further herein.

Host system 102 is in communication with databases 116-126, which may be implemented using a variety of devices for storing electronic information. It is understood that one or more of the databases 116-126 may be implemented using memory contained in the host system 102, or may be stored in separate physical devices. As shown in FIG. 1, databases 124 and 126 are logically addressable as consolidated data sources across a distributed environment that includes network 110, while databases 116-122 and 128 are in direct communication with the host system 102. It will be understood that other network configurations may be implemented in order to realize the advantages of the invention. Information stored in the databases 116-126 may be retrieved and manipulated via the host system 102. As shown in the system of FIG. 1, the host system 102 operates as a database server and coordinates access to application data including data stored in databases 116-122 and 128, while databases 124 and 126 are stored in remote systems and are accessible to the host system 102 by common services tool 108 via network 110.

Databases 116-122 include a technology qualification database 116, an audit database 118, a process/product change notification (PCN) database 120, and a supplier quality management database 122. Database 116 stores e.g., technical information such as audit specifications, industry quality standards, as well as standardized reporting forms for selection by an auditor of host system 102. A user of host system 102, such as an auditor, may need to know what the minimum industrial standards are for a certain product or component in order to verify whether a supplier is in conformance with those standards. An auditor may also want to access database 116 to ensure that the quality information sought via the scheduled audit is in conformance with host system's 102 audit specifications.

Before integrating a supplier technology into an OEM's product, a supplier is often subjected to a rigorous audit to ensure that correct technical processes are followed and to ensure technical capability. Database 118 stores results of audits performed by the manufacturing entity of host system 102 for its suppliers (e.g., supplier system 104).

Database 120 stores process/product change notifications (PCNs). Product/process changes may include both long term and short term changes to a supplier product that are initiated by the supplier. PCNs may include documents that supply chain partners (e.g., supplier system 104) send to an OEM to notify the OEM that either something in the devices under production is changing or a production process technique is changing which may trigger the need to re-qualify a device or process. The re-qualification process tests the new changes to ensure compatibility with larger assemblies or final products for which the devices will be incorporated.

Database 122 stores supplier quality management data. Supplier quality management data includes performance indicators for audited suppliers measured by, e.g., business rules adopted by host system 102 in order to compare and rate various suppliers. This information allows host system 102 to spot performance trends among suppliers audited such as areas of strength or weakness, specific technology capabilities, as well as other performance factors. It may also create a historical view of all audits performed so that host system 102 can quickly determine when or whether a supplier should be scheduled for an audit.

The databases may be stored in one or more storage devices, which in turn, may be implemented using one or more servers operating in response to a computer program stored therein or in a storage medium accessible by the server or servers (e.g., in a manner similar to that described above with respect to host system 102).

Network 110 may be any type of known network including, but not limited to, a local area network (LAN), a wide area network (WAN), a global network (e.g. the Internet), a private network (e.g. an Intranet), and a virtual private network (VPN). The network 110 may be implemented using a wireless network or any kind of physical network implementation known in the art. Network entities (e.g., supplier system 104, procurement engineering system 106, and common services tool 108 may be coupled to the host system 102 through multiple networks (e.g., intranet and Internet) so that not all network entities are coupled to the host system 102 through the same network. One or more of the network entities and the host system 102 may be connected to the network 110 in a wireless fashion.

Supplier system 104 and procurement engineering system 106 refer to communication devices through which users at one or more geographic locations may contact the host system 102. Supplier system 104 is operated by a supplier of the manufacturing entity of host system 102. A supplier may be a third party manufacturer that provides manufacturing services for an OEM (e.g., host system 102) under an outsourcing arrangement. The supplier provides technology information to the host system 102 for use in implementing the technology management activities described herein. It will be understood that multiple supplier systems 104 may be implemented in performing the technology management activities.

Procurement engineering system 106 is operated by a procurement engineer of the manufacturing entity of host system 102. The procurement engineer is tasked with facilitating the technology management activities described herein via the technology management application 114 and user interface. Monitoring and analysis can be performed using the search facilities provided by the technology management application 114.

Each system 104-106 may be implemented using a general-purpose computer executing a computer program for carrying out the processes described herein. The systems 104-106 may be personal computers (e.g., a lap top, a personal digital assistant) or host attached terminals. If the systems 104-106 are personal computers, the processing described herein may be shared by the system 104-106 and the host system 102 (e.g., by providing an applet to the system).

Common services tool 108 may be implemented via an interface that receives queries from the host system 102, searches one or both of databases 124 and 126 in response to the queries, and provides responses thereto over network 110. Common services tool 108 may be implemented by a computer processor that is in communication with systems 124 and 126, as well as with host system 102 over the network 110.

Part number management system 124 may be implemented via a data warehouse that stores data associated with each part or component used in the manufacturing processes conducted by suppliers, the OEM, or a combination thereof. The part number management system 124 may be hosted by the OEM of host system 102 or may be a commercial database hosted by a third party entity.

Machine management system 126 stores data for finished products, assemblies, and/or subassemblies of the products sold by the OEM of host system 102. Examples of data stored in machine management system 126 include manufacturing product serial numbers, manufacturing site, machine type, machine model, machine serial number, and commodities.

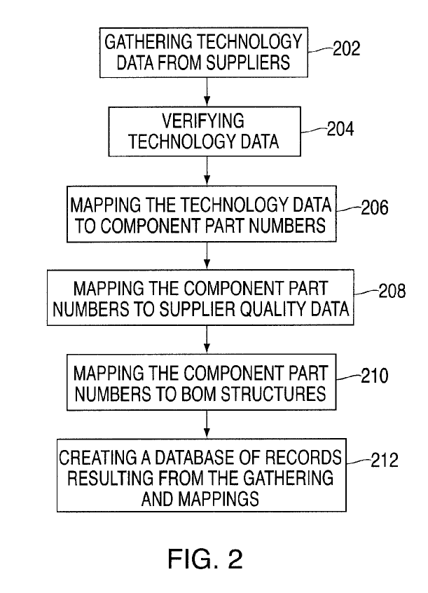

As described above, the technology management activities provide a searchable database that enables manufacturers (e.g., host system 102) to derive specific information regarding quality, function, and reliability issues occurring at any point in the supply chain. Turning now to FIG. 2, a process for implementing the technology management activities will now be described in accordance with exemplary embodiments. At step 202, technology information is gathered from suppliers (e.g., supplier system 104). The technology information may be gathered indirectly from the suppliers. For example, a procurement engineer at system 104 searches audit database 118 via the technology management application 114 and learns that a supplier has implemented a new technology which is reflected in the audit report.

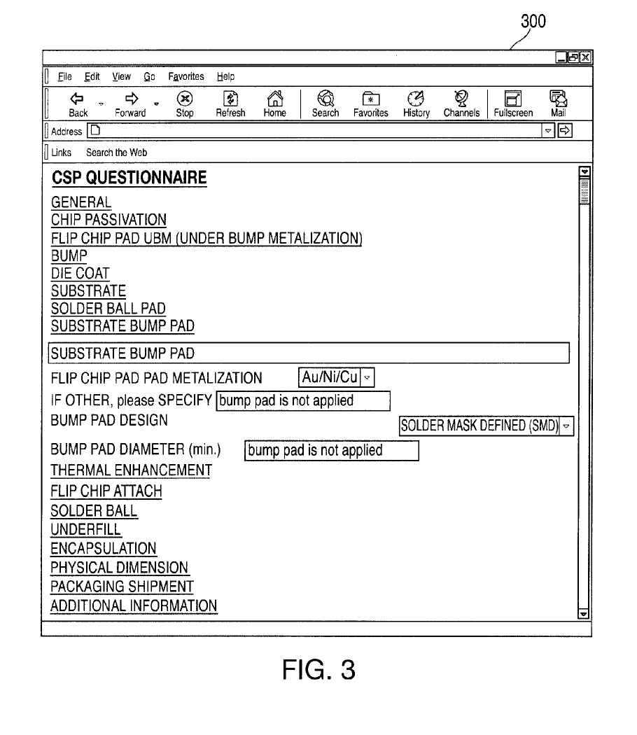

Technology information may also be gathered directly from suppliers via, e.g., PCNs provided by suppliers to the host system 102 over network 110. A PCN that is submitted by a supplier at system 106 indicates that a new technology, or change to an existing technology is underway. The receipt of this PCN may trigger the technology management application 114 to gather technology information from the PCN. The technology management application 114 retrieves a questionnaire from technology management database 128 that is applicable to the technology detected and transmits the questionnaire to the supplier at system 104. Multiple questionnaires may be created and stored in technology management database depending upon the type of manufacturing performed by the suppliers and OEM. A user interface screen depicting a sample questionnaire as seen by a supplier is shown and described in FIG. 3.

As shown in the questionnaire of user interface screen 300, the technology at issue is chip skill packaging (CSP). The questionnaire includes standardized information elements for selection and input by a supplier for a specific technology. The technology may be a new material used or a new process applied in the manufacturing of a product or component. The technology management application 114 collects the responses to the questionnaires.

At step 204, the technology information provided by the supplier in response to the questionnaire is verified. The verification may include initiating an on-site audit of the supplier to observe the new technology or initiating testing procedures for the new technology.

Once verified, the technology information is mapped to component part numbers at step 206. This may be implemented by sending a query to the common services tool 108 along with the component part numbers associated with the new technology that are specified in the responses to the questionnaire. The common services tool 108 searches part number management system 124 for the component part numbers and returns a listing of these part numbers to the technology management application 114.

At step 208, the component part numbers are mapped to supplier quality data. This step may be implemented by searching database 122 for the components entered in the responses to the questionnaire. The results of the search may include supplier performance information for manufacturing processes conducted using the matching component data.

At step 210, the component part numbers are mapped to BOM structures. This may be performed by sending a query to the common services tool 108 that includes the component part numbers. The common services tool 108, in turn, searches machine management system 126 for matches and returns BOM structure data for the matches to the technology management application via the host system 102 and network 110.

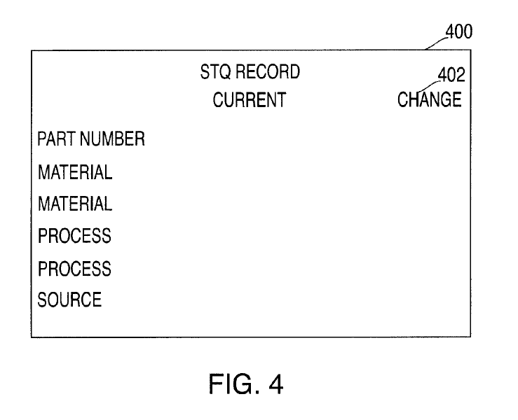

At step 212, a database of records (also referred to as supplier technology qualification (STQ) records) is created from the results of the gathering and mapping described in steps 202 and 206-210. Each record identifies a relationship between a component part number and a corresponding technology, supplier, and BOM structure. A sample STQ record 400 is shown and described in FIG. 4. The STQ record 400 provides a data field 402 for entering changes to existing parts, materials, and processes. The database of records is searchable by a number of different parameters. For example, a part or component number search may be performed for components that use a specific material. Using the semiconductor industry as an example, the materials used may include ROHS, SOI, and/or OLGA substrates. In another example, a part or component number search may be performed for components that are manufactured using a particular manufacturing process. Continuing with the semiconductor industry example above, the process may include 300 mm, laser patterning, etc. In yet another example, a part or component number search may be performed for components that are manufactured at a particular site.

In addition to searching by part or component numbers, searches may be performed for a particular OEM system. For example, a search for OEM systems that use components having a particular material or that are manufactured using a given process, etc.

These search facilities also enable an OEM to monitor component quality or reliability performance indicators. For example, an OEM can monitor component quality/reliability performance for a new material and benchmark performance against other alternative materials. In another example, an OEM may monitor component quality/reliability performance for a new process and benchmark performance with alternative processes.

The technology management application 114 further enables an OEM to evaluate qualification work for new materials or manufacturing processes by correlating quality/reliability results with qualification information (e.g., correlating results of component quality/reliability performance with the conclusion of qualification for new material/manufacturing processes.

In addition, the technology management application 114 further enables an OEM to correlate material and processes (e.g., correlate OEM component supplier manufacturing audit report with supplier's input on manufacturing process description; correlate OEM component qualification data with supplier's input on material descriptions).

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. A method for managing technology information associated with a supply chain, comprising:
gathering technology data from suppliers, the technology data including materials and processes used in manufacturing components;
mapping the technology data to component part numbers for parts that utilize the materials and processes;
mapping the component part numbers to supplier quality data, the supplier quality data including supplier performance information associated with manufacturing the components; and
creating a database of records using results of the gathering and mappings, the database of records searchable by component part numbers and at least one of the:
materials;
processes; and
supplier quality data.

2. The method of claim 1, further comprising mapping the component part numbers to bill of material structures that include the component part numbers, the database of records searchable by the bill of material structures.

3. The method of claim 1, further comprising verifying the technology data gathered from the suppliers by comparing the technology data with process change notification data associated with the suppliers.

4. The method of claim 1, further comprising verifying the technology data gathered from the suppliers by comparing the technology data with technology qualification data associated with the suppliers.

5. The method of claim 1, further comprising verifying the technology data gathered from the suppliers by comparing the technology data with audit data associated with the suppliers.

6. The method of claim 1, wherein the supplier quality data includes performance indicators for audited suppliers measured by business rules adopted for comparing and rating suppliers.

7. The method of claim 1, wherein the gathering technology data from suppliers includes providing a standardized technology questionnaire to the suppliers and receiving responses to the standardized technology questionnaire.

8. A system for managing technology information associated with a supply chain, comprising:
a host system;
a technology management application executing on the host system, the technology management application performing:
gathering technology data from suppliers, the technology data including materials and processes used in manufacturing components;
mapping the technology data to component part numbers for parts that utilize the materials and processes;
mapping the component part numbers to supplier quality data, the supplier quality data including supplier performance information associated with manufacturing the components; and
creating a database of records using results of the gathering and mappings, the database of records searchable by component part numbers and at least one of the:
materials;
processes; and
supplier quality data.

9. The system of claim 8, wherein the technology management application further performs:
mapping the component part numbers to bill of material structures that include the component part numbers, the database of records searchable by the bill of material structures.

10. The system of claim 8, wherein the technology management application further performs:
verifying the technology data gathered from the suppliers by comparing the technology data with process change notification data associated with the suppliers.

11. The system of claim 8, wherein the technology management application further performs:
verifying the technology data gathered from the suppliers by comparing the technology data with technology qualification data associated with the suppliers.

12. The system of claim 8, wherein the technology management application further performs:
verifying the technology data gathered from the suppliers by comparing the technology data with audit data associated with the suppliers.

13. The system of claim 8, wherein the supplier quality data includes performance indicators for audited suppliers measured by business rules adopted for comparing and rating suppliers.

14. A computer program product for managing technology information associated with a supply chain, the computer program product including instructions for executing a method, the method comprising:
gathering technology data from suppliers, the technology data including materials and processes used in manufacturing components;
mapping the technology data to component part numbers for parts that utilize the materials and processes;
mapping the component part numbers to supplier quality data, the supplier quality data including supplier performance information associated with manufacturing the components; and
creating a database of records using results of the gathering and mappings, the database of records searchable by component part numbers and at least one of the:
materials;
processes; and
supplier quality data.

15. The computer program product of claim 14, further comprising instructions for mapping the component part numbers to bill of material structures that include the component part numbers, the database of records searchable by the bill of material structures.

16. The computer program product of claim 14, further comprising instructions for verifying the technology data gathered from the suppliers by comparing the technology data with process change notification data associated with the suppliers.

17. The computer program product of claim 14, further comprising instructions for verifying the technology data gathered from the suppliers by comparing the technology data with technology qualification data associated with the suppliers.

18. The computer program product of claim 14, further comprising instructions for verifying the technology data gathered from the suppliers by comparing the technology data with audit data associated with the suppliers.

19. The computer program product of claim 14, wherein the supplier quality data includes performance indicators for audited suppliers measured by business rules adopted for comparing and rating suppliers.

20. The computer program product of claim 14, wherein the gathering technology data from suppliers includes providing a standardized technology questionnaire to the suppliers and receiving responses to the standardized technology questionnaire.
